(19) United States
(12) Patent Application Publication
(10) Pub. No.: US 2014/0162198 A1
(43) Pub. Date: Jun. 12, 2014

(54) MULTISTAGE IONIZER FOR A COMBUSTION SYSTEM

(71) Applicant: ClearSign Combustion Corporation, Seattle, WA (US)

(72) Inventors: IGOR A. KRICHTAFOVITCH, KIRKLAND, WA (US); CHRISTOPHER A. WIKLOF, EVERETT, WA (US)

(73) Assignee: ClearSign Combustion Corporation, Seattle, WA (US)

(21) Appl. No.: 14/092,876

(22) Filed: Nov. 27, 2013

Related U.S. Application Data
(60) Provisional application No. 61/730,486, filed on Nov. 27, 2012.

(51) Int. Cl. F23N 5/00; H01T 23/00

(52) U.S. Cl. CPC F23N 5/00; H01T 23/00
USPC 431/2; 431/253; 361/231

(57) ABSTRACT

A combustion reaction is supported. Charge carriers traveling in an ion flow path are ionized by a plurality of ionizer stages along the ion flow path. The ionized charge carriers are drawn from components of the combustion reaction, and are introduced to the combustion reaction. A charge is imparted to the combustion reaction by the ionized charge carriers. Electrical energy can then be applied to the combustion reaction, which responds according to the charge imparted by the ions.

The present application claims priority benefit from U.S. Provisional Patent Application No. 61/730,486, entitled “MULTISTAGE IONIZER FOR A COMBUSTION SYSTEM”, filed Nov. 27, 2012; and to the U.S. Provisional Patent Application No. 61/737,672, entitled “COMBUSTION CONTROL ION GENERATOR INCLUDING SEMICONDUCTIVE FOAM STRUCTURE”, filed Dec. 14, 2012; which applications, to the extent not inconsistent with the disclosure herein, are incorporated herein by reference in their entireties.

The following U.S. patent applications, filed concurrently herewith, are directed to subject matter that is related to or has some technical overlap with the subject matter of the present disclosure, and are incorporated herein by reference, in their entireties: U.S. patent application Ser. No. ______, attorney docket number 2651-064-03; U.S. patent application Ser. No. ______, attorney docket number 2651-065-03; U.S. patent application Ser. No. ______, attorney docket number 2651-072-03; U.S. patent application Ser. No. ______, attorney docket number 2651-073-03; and U.S. patent application Ser. No. ______, attorney docket number 2651-100-03.

### SUMMARY

In an embodiment, a system is provided for employing an ionizer mechanism that includes a plurality of ionizer stages to control a combustion reaction. The system includes a first electrode configured to apply electrical energy to the combustion reaction at a burner or fuel source. The system also includes a plurality of ionizer stages configured to be positioned in series along a charged particle flow path coupled to the combustion reaction. The system also includes a voltage source configured to be operatively coupled to the first electrode and the ionizer mechanism. The system further includes a controller configured to be operatively coupled to the voltage source and the plurality of stages of the ionizer mechanism. The controller is configured to control the plurality of stages of the ionizer mechanism to ionize charge carriers to impart a charge to the combustion reaction. The controller is further configured to control the voltage source to apply the electrical energy to the combustion reaction via the first electrode, causing a response by the combustion reaction, due to the charge applied by the charge carriers.

In an embodiment, a method is provided for employing multistage ionization to control a combustion reaction. The method includes supporting a combustion reaction at a burner or fuel source, ionizing charge carriers drawn from one or more components of the combustion reaction in a plurality of ionizer stages along an ion flow path to create ionized charge carriers, and introducing the ionized charge carriers to the combustion reaction. The method also includes imparting a charge to the combustion reaction via the ionized charge carriers. The method further includes controlling one or more parameters associated with the combustion reaction by applying electrical energy to the combustion reaction, and thereby provoking a response by the combustion reaction because of the charge imparted via the ionized charge carriers.

### BRIEF DESCRIPTION OF THE DRAWINGS

FIG. 1 is a diagram of a combustion system including a plurality of ionizer stages to inject charges into a combustion reaction, according to an embodiment.

FIG. 2A is a diagram of a pair of ionizer stages shown in FIG. 1, according to an embodiment.

FIG. 2B is a diagram showing a typical voltage/current curve of a corona discharge.

FIG. 3A is a diagram of a variety of conduits configured to inject charges into the combustion reaction, according to embodiments.

FIG. 3B is a diagram of a system including a conduit for injecting charges into the combustion reaction, according to an embodiment.

FIG. 4 is a diagram of a system including a plurality of ionizer stages operatively coupled to a charge carrier source, according to an embodiment.

FIG. 5 is a diagram of a counter electrode for use in an ionizer mechanism, according to an embodiment.

FIG. 6 is a diagram showing a combustion system, according to an embodiment, that includes the counter electrode of FIG. 5.

FIGS. 7 and 8 are diagrams showing multi-stage ionizer mechanisms, according to respective embodiments.

FIG. 9 is a flow chart of a method for using an ionizer mechanism to control a combustion reaction, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments is used and/or other changes is made without departing from the spirit or scope of the disclosure.

The inventors have recognized that electrodes in contact with, or in close proximity to the combustion reaction may be damaged by heat or reactive species from the combustion reaction, which can reduce the ability to control the combustion reaction. For example, electrodes with limited surface area, small radius of curvature, and/or sharp edges, such as may be employed for charge injection or corona electrodes, are frequently susceptible to such damage. Additionally, electrodes made from certain materials may be susceptible to such damage, in some cases so susceptible that such damage may discourage the use of otherwise desirable electrode materials for cost or practicality reasons. Moreover, electrode replacement is costly in terms of combustion reaction downtime, electrode materials, and/or labor, not to mention reduced control efficiency of such electrodes prior to replacement.

According to some embodiments, a combustion reaction charging system having “active”, or current-carrying parts in a combustion volume, may require a more extensive procedure to replace broken or worn parts and/or may require shutdown or large fuel turn-down to access the broken or worn parts. Accordingly, service and reliability can be positively affected by placing active parts outside the combustion volume.

The inventors propose providing an ionizer mechanism configured to ionize charge carriers that are then introduced to the combustion reaction, as a means of applying an electrical charge to the combustion reaction. The charge carriers can be drawn from any appropriate material or combination of materials, including, for example, components of the combustion reaction, such as oxidizer gas (e.g., air), fuel, flue gas, reactants, etc. According to an embodiment, the mechanism may include an ion beam generator, such as an electron beam source. According to another embodiment, the mechanism may include a corona electrode and counter electrode pair immersed in a flow of dielectric fluid, such as a gas, which is then introduced into the combustion volume. The corona electrode and counter electrode pair are configured to create ions from molecules of the dielectric fluid, or from other donor substances carried by the fluid.

The ionizer mechanism may be provided as a module or modular system configured for field exchange or replacement.

One difficulty in employing an ionizing mechanism is that known ionizers generally are not configured to produce ions in quantities sufficient to significantly modify aspects of a combustion reaction, particularly in large industrial applications. According to various embodiments, structures and methods are provided for producing increased quantities of ions and delivering those ions to a combustion reaction.

The term combustion reaction is to be construed as referring to an exothermic oxidation reaction. In some cases a combustion reaction can include a stoichiometric (e.g., visible) surface. In other cases, the combustion reaction may be “flameless” such that no visible boundary exists.

Combustion components refers to elements that are to be introduced into the combustion volume, and that will be involved in the combustion process, such as fuel, oxidizer, EGR flue gases, modifiers, catalysts, and other substances that may be introduced. This term is not limited to reference to these elements as they are present within the combustion volume, but also prior to their introduction into the combustion volume.

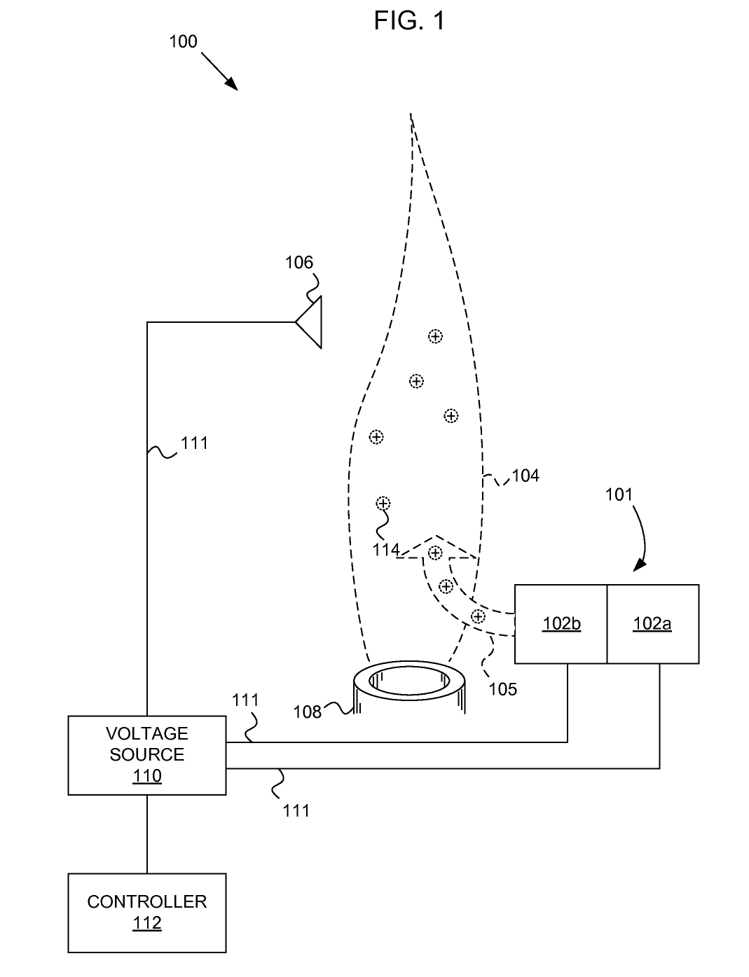

FIG. 1 is a diagram of a combustion system 100 including an ionizer mechanism 101 configured to inject a charge into a combustion reaction 104, according to an embodiment. The system 100 further includes a first electrode 106 configured to apply an electrical field and/or voltage (referred to hereafter as electrical energy) to the combustion reaction 104, and a burner 108 configured to support the combustion reaction 104.

The ionizer mechanism 101 is configured to inject the charge in the form of ions 114 traveling along an ion flow path 105. The ion flow path is positioned to merge with the combustion reaction 104, resulting in the incorporation of the ions 114 into the combustion reaction 104. In the embodiment shown in FIG. 1, the ionizer mechanism 101 includes a first ionizer stage 102a and a second ionizer stage 102b, and can include additional ionizer stages, according to the requirements of the particular application. The second ionizer stage 102b is disposed downstream along the ion flow path 105 from the first ionizer stage 102a.

Ions 114 are shown in the drawings as having a positive charge or polarity. This is merely for convenience: it is well known that ions can have either a positive charge (cations) or a negative charge (anions).

A voltage source 110 is operatively coupled by connectors 111 to the first electrode 106 and to the ionizer stages 102 of the ionizer mechanism 101. According to an embodiment, a controller 112 is included in the system 100, operatively coupled to the voltage source 110. The controller 112 is configured to control operation of the system 100, which may include controlling the signal provided by the voltage source 110 to the first electrode 106, as well as signals provided to the ionizer stages 102 to control ionization of charge carriers that are then introduced into the combustion reaction as ions 114. The charge carriers are preferably molecules or particles of one or more components of the combustion reaction 104. The ionized charge carriers impart a charge to the combustion reaction 104, so that the combustion reaction has a net positive or negative charge—depending upon the charge polarity of the ions introduced into the system. The combustion reaction 104 can thus be influenced by or react to the electrical energy applied by the first electrode 106. Additionally, the charge carriers may constitute a portion of a feedback loop by which the voltage source 110 and/or the controller 112 regulate selected parameters of the combustion reaction 104.

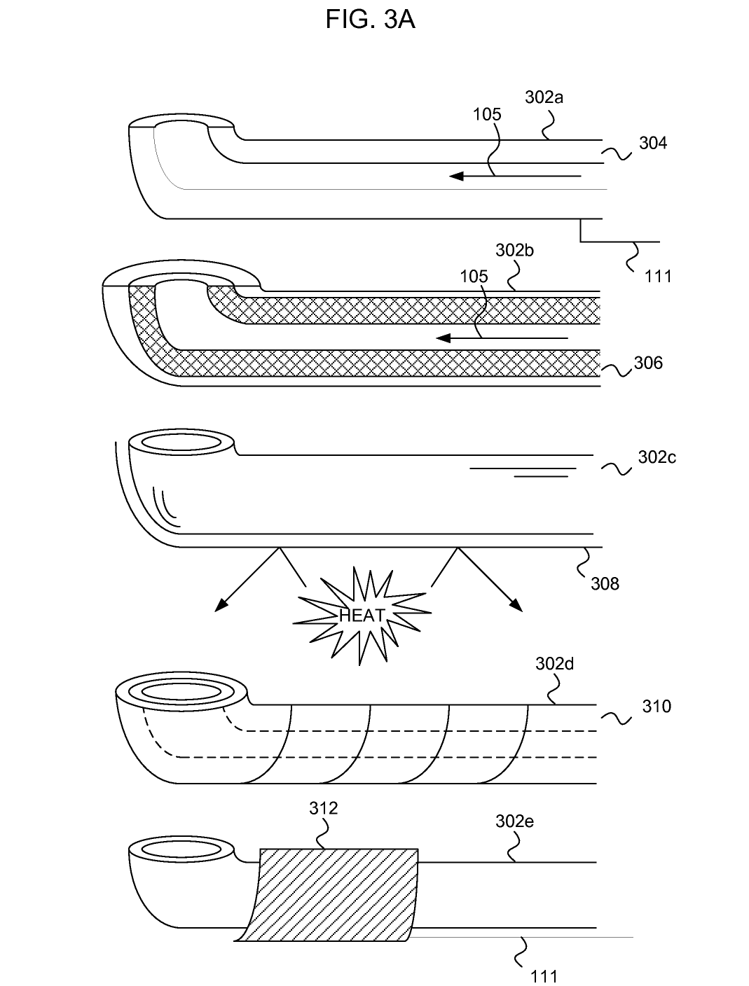

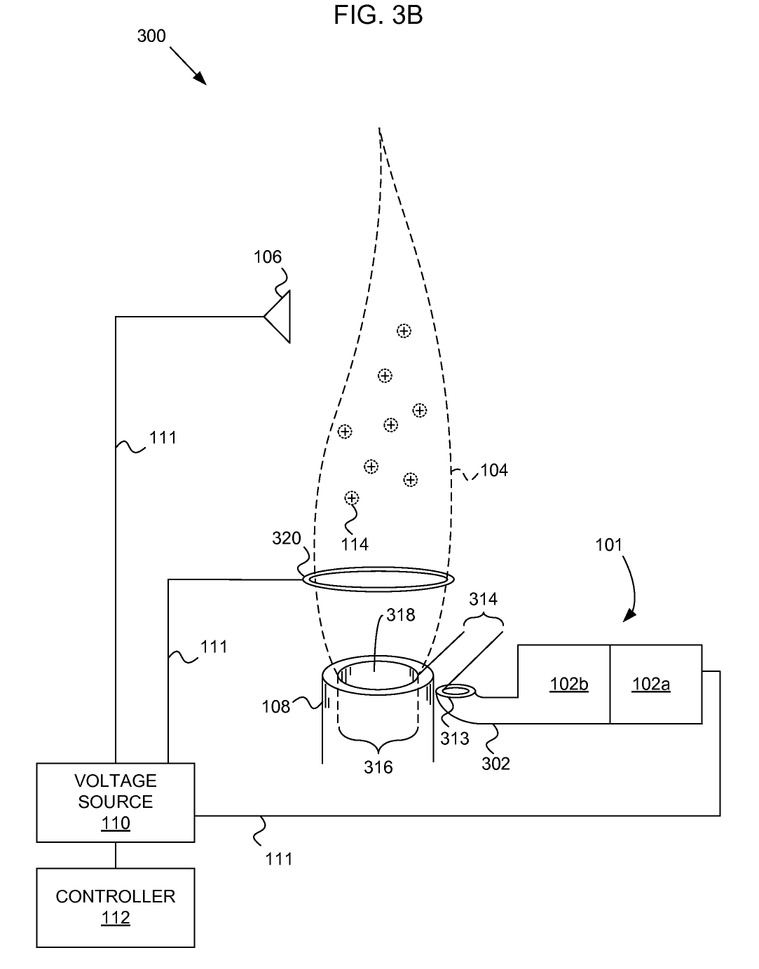

The electrical energy applied by the voltage source 110 to the first electrode 106 is selected to interact with the charge introduced by the ions 114, to control the combustion reaction 104. For example, assuming that the charge applied has a positive polarity, application of a negative voltage to the first electrode 106 will cause portions of the combustion reaction to be attracted to the first electrode 106. This reaction might be employed, for example, to anchor a flame portion of the combustion reaction 104, or to control a shape of the flame portion, etc. On the other hand, application of a positive voltage to the first electrode 106 would cause charged portions of the combustion reaction to be repelled by the first electrode 106. This reaction might be employed to direct the combustion reaction to a specific location within the combustion volume, etc. Furthermore, by employing additional electrodes positioned at selected locations in or near the combustion reaction 104, and by applying voltages of different magnitudes and/or polarities, a higher degree of control can be imposed on the combustion reaction 104. One example is described in more detail below, with reference to FIG. 3B.

It should be noted that, in contrast to the known ECC system described above in the background, in which the burner nozzle is employed as a second electrode in order to apply electrical energy to a combustion reaction, the combustion reaction 104 of the system 100 can be charged at a polarity that is the same as the polarity of the first electrode. In other words, for example, positively charged ions can be introduced, in order to produce a net positive charge in the combustion reaction, while at the same time, a voltage applied to the first electrode 106 can have a positive polarity. This distinction is due to the fact that, in the prior art system, the first electrode is employed as part of the charging mechanism, as well as a control element. In other words, in the prior art system, an electrical field that is established between the first electrode and the burner nozzle electrode is employed to energize the combustion reaction, and, additionally, the first electrode is employed to control one or more characteristics of the combustion reaction. In contrast, in the system 100 of the present disclosure, the first electrode 106 can be employed as a control element, only. A charge is applied to the combustion reaction 104 of the system 100 independent of the first electrode 106, so there is no necessary correlation between the polarity or magnitude of the charge applied to the combustion reaction 104 and the polarity or magnitude of the energy applied by the first electrode 106.

Of course, a system designer is free to employ the first electrode 106 to impart additional energy to the combustion reaction, or to discharge some portion of the energy imparted by the ions 114. Furthermore, additional electrodes positioned and configured to interact directly with the combustion reaction can also be used, as described below with reference to FIG. 3B, for example.

The electrical energy applied to the combustion reaction 104 by the first electrode 106 may be applied as, for example, a charge, a voltage, an electrical field, or a combination thereof. The electrical energy may be applied as a substantially constant (DC) voltage, electric field, or charge flow. Alternatively, the electrical energy may be applied as a time-varying majority charge flow, a time-varying voltage, or a time varying electric field. The electrical energy may be applied as time-varying on a DC bias. The time-varying electrical energy may include an alternating current (AC) having positive and negative portions. Alternatively, the time-varying electrical energy may be applied as a chopped or synthesized waveform of a single polarity, and can vary between a ground potential and a maximum potential, or can be offset from ground. Furthermore, the first electrode 106 can be configured to periodically float with respect to the voltage source 110.

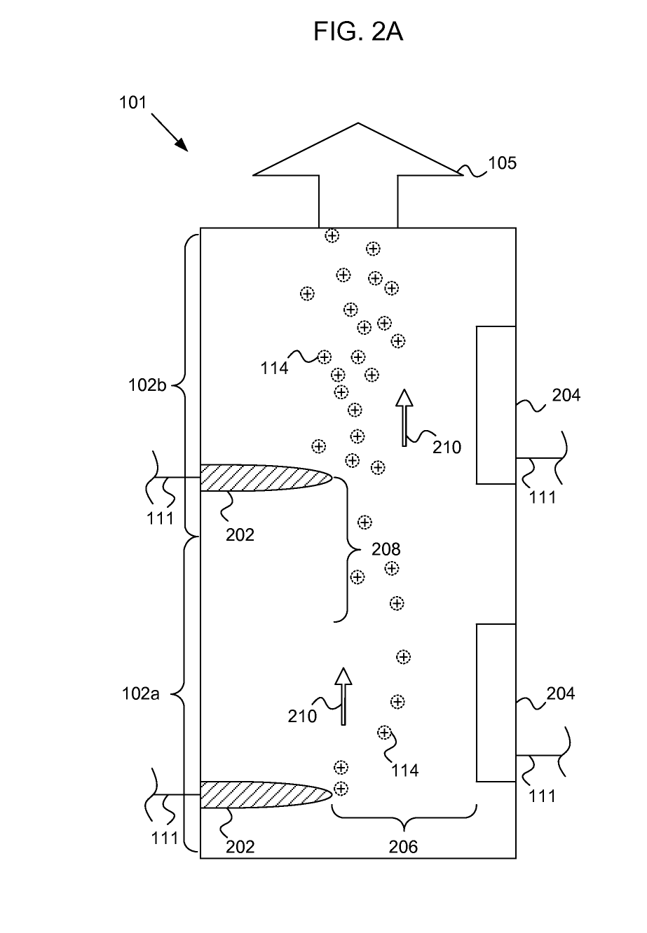

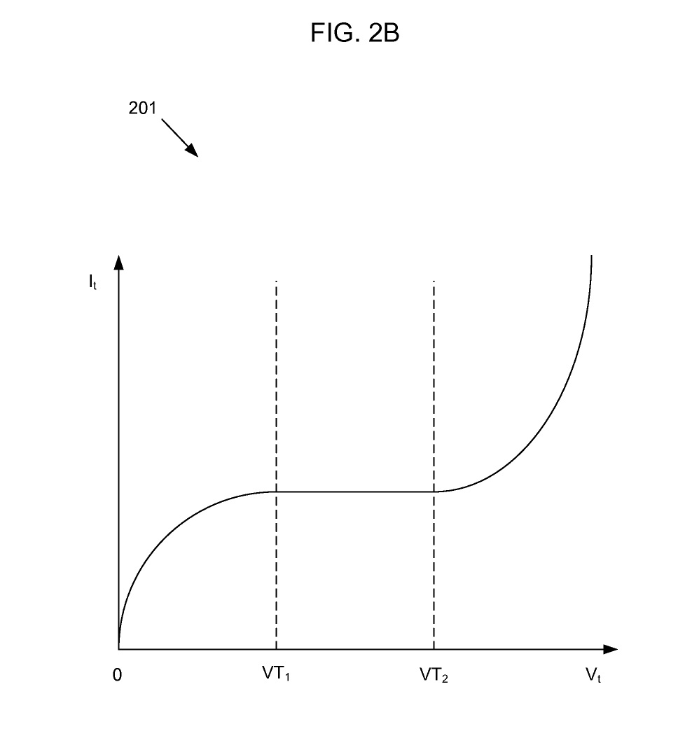

FIG. 2A is a diagram showing the ionizer mechanism 101 of FIG. 1, according to an embodiment. Each ionizer stage 102a, 102b includes a corona electrode 202 and a counter electrode 204, spaced apart by an electrode separation distance 206. Each ionizer stage 102 is operatively coupled to the voltage source 110 via the connectors 111. Each ionizer stage 102 is also operatively coupled to the controller 112. The operative coupling of the ionizer stages 102 to the controller 112 can be via the voltage source 110 and the corresponding connector 111, as shown in FIG. 1, or can be by any other appropriate means, such as by a separate connector.

The ion flow path 105 extends between the corona electrode 202 and the counter electrode 204 of each of the ionizer stages 102. A transport fluid 210 flows along the ion flow path 105 carrying ions along the flow path toward the combustion reaction. The transport fluid 210 is most commonly the substance from which the charge carriers are drawn, but in some cases, it can be a fluid in which another material is suspended, the other material being more susceptible to ionization, and thus more likely to contribute the charge carriers. Preferably, the transport fluid 210 is a combustion component, such as air, fuel, or EGR flue gas, for example. The transport fluid 210 is preferably a dielectric, or at least has a very low conductivity, in order for proper operation of the ionizer stages 102.

In the embodiment shown, the first ionizer stage 102a is positioned upstream from the second ionizer stage 102b along the ion flow path 105. Further downstream from the second ionizer stage 102b, the ion flow path 105 merges with the combustion reaction 104 substantially as described with reference to FIG. 1. The relative positions, flow-wise (i.e., along the ion flow path 105), of the electrodes of each of the ionizer stages 102 may vary, according to the design of the device. For example, the corona electrode 202 may be aligned with the upstream edge of the counter electrode 204, as shown in FIG. 2, or may be positioned further up- or down stream than shown. Additionally, the first and second ionizer stages 102a, 102b are spaced apart by an inter-ionizer separation distance 208, which represents the nearest flow-wise approach between an electrode element of the first ionizer stage 102a and an electrode element of the second ionizer stage 102b. According to an embodiment, the first and second ionizer stages 102a, 102b are positioned such that the inter-ionizer separation distance 208 is greater than the electrode separation distance 206 of the first ionizer stage 102a.

According to an embodiment, the inter-ionizer separation distance 208 is between about 1.5 times and about 2.5 times the electrode separation 206 of the first ionizer stage 102a. For example, according to an embodiment, the inter-ionizer separation distance 208 is about 2 times the electrode separation 206 of the first ionizer stage 102a. An inter-ionizer separation distance 208 that is greater than the electrode separation distance 206 tends to prevent a corona electrode 202 of one ionizer stage from interacting with a counter electrode of another ionizer stage.

Additionally, in systems in which the ionizer mechanism 101 includes more than two ionizer stages 102, for each adjacent pair of ionizer stages, the inter-ionizer separation 208 is, according to an embodiment, between about 1.5 and 2.5 times—preferably about 2 times—the electrode separation 206 of the upstream one of the respective pair of ionizer stages 102. The number of ionizer stages in the plurality of ionizer stages 102 can be any number that is sufficient to produce a desired quantity of ions, including 3, 4, 5, 6, 7, 8, 9, 10, 11, or 12, for example.

Referring to FIGS. 1 and 2A, according to an embodiment, the controller 112 is configured to independently control a polarity of each ionizer stage 102. Thus, the controller 112 may control each ionizer stage 102 to have a same polarity, to have opposite polarities, or to have independent time-varying signals applied.

According to an embodiment, one or more of the ionizer stages 102 includes a corona electrode 202 that includes silver. According to another embodiment, the controller 112 is configured to detect a short circuit at a corona electrode 202 of any of the ionizer stages 102. Upon detection of a short circuit, the controller 112 is configured to reduce or shut off a voltage applied to the corona electrode 202 at which the short circuit is detected. The voltage source 110 is configured to apply a voltage Vₜ between the corona electrode 202 and the corresponding counter electrode 204 of each of the ionizer stages 102, causing a corona current Iₜ to flow between the corona electrode 202 and the counter electrode 204. In a typical electrical circuit, the current consists of a flow of electrons. I contrast, in an ionizer circuit, the current is primarily a flow of ions. In an ionizer circuit, the current across the gap between the corona and counter electrodes, i.e., the corona current, is proportional to the quantity of ions produced. The value of the corona current Iₜ is determined by a number of factors, including the voltage Vₜ, the dielectric breakdown voltage of the surrounding fluid, the shape of the corona electrode, the electrode separation distance, etc.

FIG. 2B shows a typical voltage/current curve of a corona discharge. At voltage levels below a first voltage threshold VT₁, variations in the corona current Iₜ are directly related to variations of the voltage Vₜ. However, when the voltage Vₜ increases beyond the first voltage threshold VT₁, ion saturation occurs, and corona current Iₜ remains substantially constant while the voltage Vₜ is between the first voltage threshold VT₁ and a second voltage threshold VT₂. As the voltage Vₜ increases beyond the second voltage threshold VT₂, the dielectric strength of the transport fluid is exceeded and ion avalanche occurs (i.e., Townsend discharge), in which a conductive path is formed between the corona electrode and the counter electrode, and an electron current begins to flow, quickly forming an electrical arc that short-circuits the ionizer stage. Hereafter, this phenomenon will be referred to as an electrical breakdown of the ionizer, and the voltage at which an electrical breakdown is initiated as the electrical breakdown voltage.

Inasmuch as the corona current Iₜ is substantially proportional to the quantity of ions produced, it will be recognized that at voltages Vₜ beyond the first voltage threshold VT₁, production of ions does not change substantially, regardless of changes in the voltage. Thus, there is a practical limit to the quantity of ions that such an ion generator can produce.

While the voltage/current curve shown in FIG. 2B is representative of many systems, it is not representative of every corona discharge system. In some cases, depending on the design of the system, the first and second thresholds VT₁, VT₂ are much closer together, such that there is a narrower range in which the ion current is constant. In other cases, the first and second thresholds VT₁, VT₂ are effectively the same value, meaning that electrical breakdown of the ionizer occurs at the same voltage, or even at a lower voltage than ion saturation. In such cases, the maximum corona current Iₜ value is limited by the voltage at which electrical breakdown occurs. This is often the case, particularly, in ion generation systems that are optimized for maximum ion production. In such systems, the electrodes are frequently positioned very close together, in order to produce a very strong field gradient. However, the electrical breakdown voltage of a system is in part a function of the electrode separation distance across which the voltage is applied. As the electrode separation distance is reduced to increase ion production, the electrical breakdown voltage also drops, increasing the risk of a short circuit.

The inventors have recognized that the electrical breakdown voltage is a limiting factor in the quantity of ions that can be produced by an ionizer, and have developed methods and structures that enable an ionizer to produce an increased quantity of ions. According to various embodiments, a plurality of ionizer stages are provided. By positioning a plurality of ionizer stages in series along the ion flow path, the quantity of ions is not limited by the ion saturation threshold or by the electrical breakdown voltage of the system.

According to some embodiments, systems are provided that enable applying a voltage in excess of the nominal electrical breakdown voltage of a stage, without producing an arc discharge between the electrodes. According to an embodiment, the controller 112 is configured to apply a time-varying voltage to the corona electrode 202 and the counter electrode 204 of one or more of the ionizer stages 102. While in some cases it may be beneficial to periodically reverse the polarity of the voltage to the electrodes, in others, it is preferable to maintain a same polarity. Accordingly, the signal applied may constitute an AC voltage with a DC offset. The DC offset value can be selected to be equal to half the peak-to-peak amplitude of the AC signal, so that the applied voltage varies between a maximum value equal to the twice the peak AC amplitude—when the polarity of the AC signal is the same as that of the DC signal, so that the applied voltage is a sum of the signals—and zero, or ground potential—when the signal polarities are opposite each other, and thus cancel. In other cases, the DC offset may be greater than half the peak-to-peak amplitude of the AC signal, so that the applied voltage varies between a minimum value corresponding to the difference between the DC offset and the peak AC voltage, and a maximum value corresponding to sum of the DC offset voltage and the peak AC voltage. In another example, the DC offset voltage is selected to be much greater than the amplitude of the AC signal, such as, e.g., one, two, three, or more orders of magnitude greater, so that the resulting signal is a primarily DC voltage with a relatively small ripple voltage imposed. In any event, the signal applied across the corona and counter electrodes will have an effective minimum voltage that is equal to the difference between the DC offset voltage and the peak AC voltage, and an effective maximum voltage that is equal to the sum of the DC offset voltage and the peak AC voltage.

There is a finite delay between the instant the applied voltage exceeds the electrical breakdown voltage and the instant an arc discharge is fully formed between the electrodes, during which a path of conductive ions forms across the gap. The length of the delay is influenced by a number of factors, such as, for example, the dielectric strength of the fluid, the size of the electrode separation, the absolute value of the applied voltage, the value of the applied voltage relative to the electrical breakdown voltage, etc. This delay can be referred to as the arc discharge delay.

According to an embodiment, a signal is applied across the corona and counter electrodes 202, 204 of one or more of the stages 102 of the ionizer mechanism 101. The applied signal includes an AC component and a DC offset value. The signal is selected to have an effective minimum voltage that is equal to or below the nominal electrical breakdown voltage of the respective stage, and an effective maximum voltage that is equal to or greater than the nominal electrical breakdown voltage. A frequency and waveform of the AC component of the signal is selected to permit the time-varying amplitude of the signal to rise above the nominal electrical breakdown voltage, reach the effective maximum voltage, and return below the nominal electrical breakdown voltage in a period that is no longer than the arc discharge delay. The period during which the applied voltage is below the nominal electrical breakdown voltage is selected to be sufficient to permit any partially formed ion path between the electrodes to dissipate prior to a succeeding cycle. In this way, voltages far in excess of the nominal electrical breakdown voltage can be repeatedly applied without creating an arc discharge.

The inventors have determined that some configurations of ionizer systems can produce greater quantities of ions by applying a voltage signal that includes an AC and a DC component than would be possible with a constant DC signal. Appropriate values of the AC and DC components, as well as of the waveform and frequency, can vary widely and to a large degree are interrelated. For example, a extreme voltage excursion beyond the nominal electrical breakdown voltage may reduce the arc discharge delay, and so require a higher signal frequency and or a lower duty cycle of the signal (i.e., the ratio of time in which the signal is above the breakdown voltage value, relative to the time during which the signal is below the breakdown voltage).

According to various embodiments, the maximum applied voltage can exceed 30 KV, and the signal frequency can exceed 100 KHz. Appropriate characteristic values of the applied signal are a matter of system design, and can be determined empirically, without undue experimentation.

FIG. 3A is a diagram of a variety of conduits 302a-302e configured to introduce charges into the combustion reaction, according to respective embodiments. According to the various embodiments, the conduit 302 is coupled to an outlet of the ionizer mechanism 101 and configured to convey the ion flow path 105, including the ions 114 from the ionizer mechanism 101 to the combustion reaction 104, to impart a charge onto the combustion reaction. The conduit 302 is formed from a material resistant to degradation by the ions 114 and by the combustion reaction 104. The conduit 302 may include, for example, butyl rubber, perfluoroelastomer (Chemraz), chlorinated polyvinyl chloride, high-silicon iron alloy (greater than about 14% silicon, e.g., Durachlor-51), ethylene propylene diene monomer rubber (EPDM), ethylene-propylene rubber (EPR), polyethylene (high density polyethylene, low density polyethylene, ultra high molecular weight polyethylene, FLEXELENE®, KFLEX®), fluorosilicone, galvanized steel, glass, corrosion resistant high nickel content superalloy (HASTELLOY-C®), austenitic nickel-chromium-superalloy (INCONEL®), perfluoroelastomers (KALREZ®), polychlorotrifluoroethylene (PCTFE, KEL-F®), polyether ether ketone (PEEK), polycarbonate, polyurethane, polytetrafluoroethylene (TEFLON®, DURLON®), polyvinylidene difluoride (KYNAR®), crosslinked ethylene propylene diene-polypropylene. (SANTOPRENE®), silicone, stainless steel (300 series, especially 304 and 316), titanium, ethylene acrylic elastomer (VAMAC®), fluoroelastomer (VITON®), acrylonitrile-butadiene styrene polymer, aluminum, brass, bronze, copper, polyacrylate, polysulfide, polyvinyl chloride, TYGON® (various proprietary compositions, particularly Tygon R-3400 UV resistant), or a combination of two or more of these materials.

According to an embodiment, the conduit 302 is configured to be electrically insulated from the combustion reaction 104. According another embodiment, the conduit is formed from a dielectric material configured to electrically insulate the ionizer from the combustion reaction.

The ionizer mechanism 101 is configured to output a flow of transport fluid 210, including the ions 114, having a first polarity to the conduit 302. The conduit 302a is shown including a conductive material 304 operatively coupled to the voltage supply 110. The controller 112 and/or the voltage supply 110 are configured to apply a potential to the conductive material 304 of the conduit 302 at the first polarity. The conductive material 304 may include, for example, a high-silicon iron alloy, a galvanized steel, a corrosion resistant high nickel content superalloy, an austenitic nickel-chromium-superalloy, a stainless steel, titanium, aluminum, brass, bronze, copper, and/or a combination thereof. In operation, as the transport fluid 210 flows through the conduit 302, the same-polarity potential applied to the conduit 302a acts to repel ions 114 carried by the transport fluid 210, and prevent the ions from discharging against the inner surface of the conduit 302.

The conduits 302b-302e are shown including structures configured to protect portions of the conduit and its contents from the heat of the combustion reaction 104. The protective structure may include one or more of a thermal insulation 306, a thermal reflector 308, a refrigerated-jacket-type cooling apparatus 310, and/or a thermoelectric cooling apparatus 312.

FIG. 3B is a diagram of a system 300 including a conduit 302 for introducing ions 114 into the combustion reaction 104, according to an embodiment. The conduit 302 includes an outlet 313. The outlet 313 is configured to be located at a separation 314 from an outlet 318 of the burner 108. According to an embodiment, separation 314 is less than a diameter 316 of the outlet 318 of the burner 108. Additionally and/or alternatively, the outlet 313 may be located upstream of the outlet 318 of the burner 108, upstream being with respect to a flow of the combustion reaction 104.

In the embodiment shown in FIG. 3B, system 300 includes a conductive flame holder 320 acting as a second electrode. The conductive flame holder 320 is be coupled to the voltage source 110 and the controller 112, and the controller 112 configured to control the voltage source 110 to apply electrical energy to the conductive flame holder. The electrical energy applied to the conductive flame holder 320 at least intermittently holds a portion of the combustion reaction 104 at the conductive flame holder 320.

The conduit 302 is configured to direct the transport fluid 210 and ions 114 towards the conductive flame holder 320. Alternatively, the conduit 302 may be configured to direct the ions 114 towards a position that is upstream from the conductive flame holder 320, with respect to a flow of the combustion reaction 104.

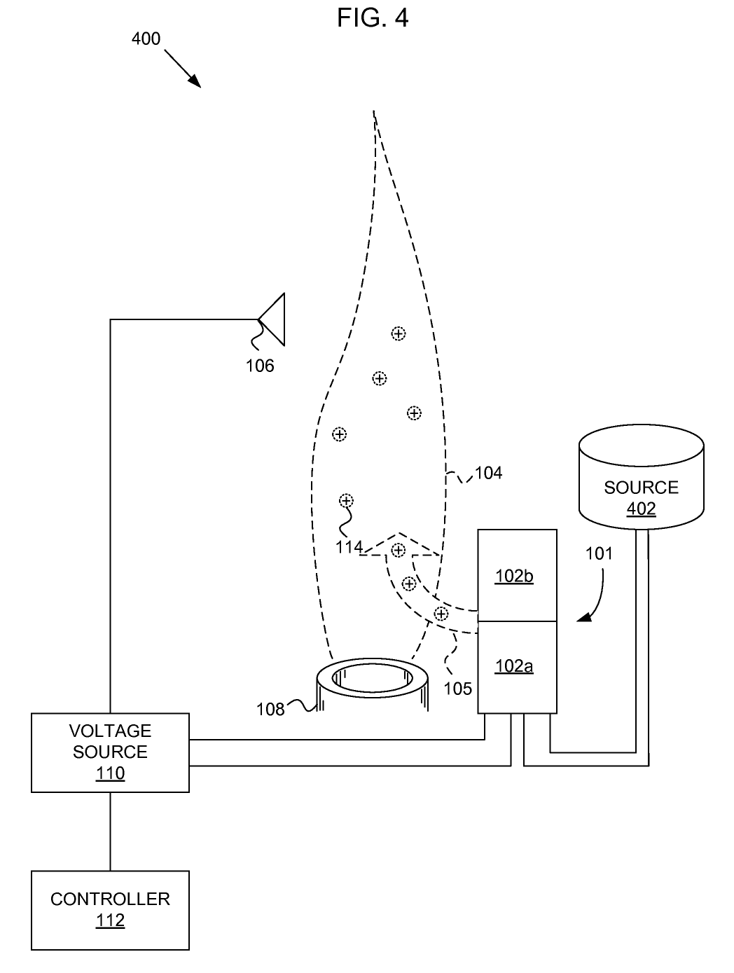

FIG. 4 is a diagram of a system 400 including an ionizer mechanism 101 operatively coupled to a charge carrier source 402, according to an embodiment. The charge carrier source 402 is configured to provide the charge carriers to the plurality of ionizer stages 102. The charge carriers may be provided to the plurality of ionizer stages 102 in the form, for example, of a fuel, an oxidant, a particulate additive, a liquid additive, a gas additive, an aerosol additive, a solute additive in a liquid solution, or a combination thereof. The charge carriers may be drawn from the transport fluid 210, or can be incorporated therewith by the charge carrier source 402. Where the charge carriers are incorporated with a separate transport fluid, the charge carrier source 402 can be configured to provide the transport fluid, as well, or the transport fluid 210 can have a separate source. The charge carrier source 402 is configured to provide the charge carriers to the ionizer mechanism 101 using, for example, one or more of a nebulizer, an atomizer, an injector, a steam generator, an ultrasonic humidifier, a vaporizer, an evaporator, a pump, and/or a combination thereof. The charge carrier source 402 is electrically isolated from the ionizer mechanism 101.

As previously noted, many ion generation systems are limited by the electrical breakdown voltage of the system. When the voltage Vₜ of such a system increases beyond a threshold, the dielectric strength of the transport fluid is exceeded, and an electrical arc may form between the electrodes of the system. The inventors have discovered that the effective electrical breakdown voltage itself can be influenced to a surprising degree by the particular structure of the counter electrode. Specifically, a counter electrode of a material having a low conductivity and a porous structure can significantly increase the effective electrical breakdown voltage of the particular transport fluid and system configuration.

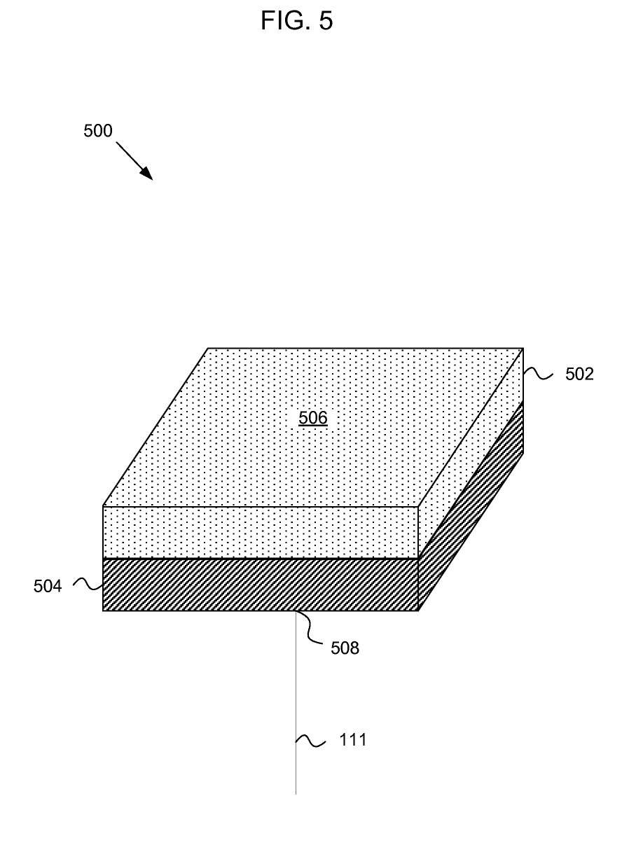

FIG. 5 is a diagram, according to an embodiment, of an electrode 500 that includes a first layer 502 of a porous material having a relatively high electrical resistance, and a second layer 504 of a highly conductive material, in close electrical contact with the first layer. A connector 111 is coupled to the second layer 504 at a contact terminal 508. The electrode 500 is configured to be positioned with a front face 506 facing a corona electrode 202 in an ionizer mechanism 101.

According to an embodiment, the first layer 502 has an open-cell foam structure having a density of between about 0.5 grams/cubic centimeter and about 0.001 grams/cubic centimeter. The material of the first layer can have, for example, an intrinsic resistance of between 10 kΩ and 10 MΩcm.

The term intrinsic resistance is used to distinguish the resistance that is inherent in the material from which the first layer is made from the resistance that is a product of the particular structure of the first layer, i.e., its porosity, thickness, density, etc.

The inventors have determined that the first layer 502 can be made from a large number of different of materials, including semiconducting materials. Materials that may be used include components of graphite, graphene, graphene oxide, reduced graphene oxide, activated carbon, amorphous carbon, foamed compositions thereof, and combinations thereof. Additionally or alternatively, the material of the first layer 502 can be a ceramic and/or an oxide. The material of the first layer 502 can include a xerogel, an aerogel, a polymer, a thermoset polymer and/or a polymer including melamine.

According to an embodiment, the material of the first layer 502 is a melamine compound that exhibits semiconducting characteristics. According to another embodiment, the material is an open cell foamed copolymer of formaldehyde-melamine-sodium bisulfite.

The intrinsic resistance of the material of the first layer 502 is a matter of design choice. Selection of the resistance may be influenced by a number of factors, such as, for example, the dielectric strength of the fluid that will be used as a transport fluid, the size, shape, and intended electrical characteristics of the counter electrode, the size of the dielectric gap, i.e., the distance between the corona electrode and the counter electrode, the thickness of the first layer, the maximum voltage that will be applied across the dielectric gap, etc. A selected intrinsic resistance can be obtained by selection of the particular material or compound used, and can be further modified, for example, by the incorporation of particles or fibers of other, more conductive materials. For example, metallic particles can be added during formation of the material of the first layer 502 to increase the conductivity of the material.

The term point contact is defined as an electrical contact with a surface covering less than about 0.5 mm² of the surface. A point contact might be achieved, for example, using a typical meter probe. Point contact resistance refers to the resistance of the electrode from a point contact on the front face 506 to the contact terminal 508. The term broad contact is defined as an electrical contact with a surface covering more than about 1 cm² of the surface. Broad contact resistance refers to the resistance of the electrode 500 from a broad contact on the front face 506 to the contact terminal 508. The point contact resistance of the electrode 500 can be varied, relative to the intrinsic resistance of the material of the first layer 502, by selection of factors such as the density, porosity, and thickness of the first layer. Additionally, varying the intrinsic resistance of the material of the first layer 502 will have a much greater impact on the point contact resistance of the electrode than on the broad contact resistance. Thus, by selection of the intrinsic resistance of the material, as well as by the selection of the density, porosity, and thickness of the first layer 502, the absolute and relative values of the point contact resistance and the broad contact resistance can be controlled.

According to an embodiment, the material of the second layer 504 is a conductive metal, and can be a plate, a foil, a wire, a mesh, a grate, a foam, a wool, a metal coating formed on on face of the first layer 502, or a combination thereof. Alternatively, the material of the second layer can be a non-metallic conductive material.

According to an embodiment, the first layer 502 is formed to wrap around the second layer 504 on the sides, as well as on the front face, in order to reduce or prevent direct interaction of the second layer 504 with an electric field formed between the electrodes.

In embodiments where the electrode 500 is to be employed within a combustion volume, the electrode, and particularly the first layer 502 can be configured to be flame- or heat resistant.

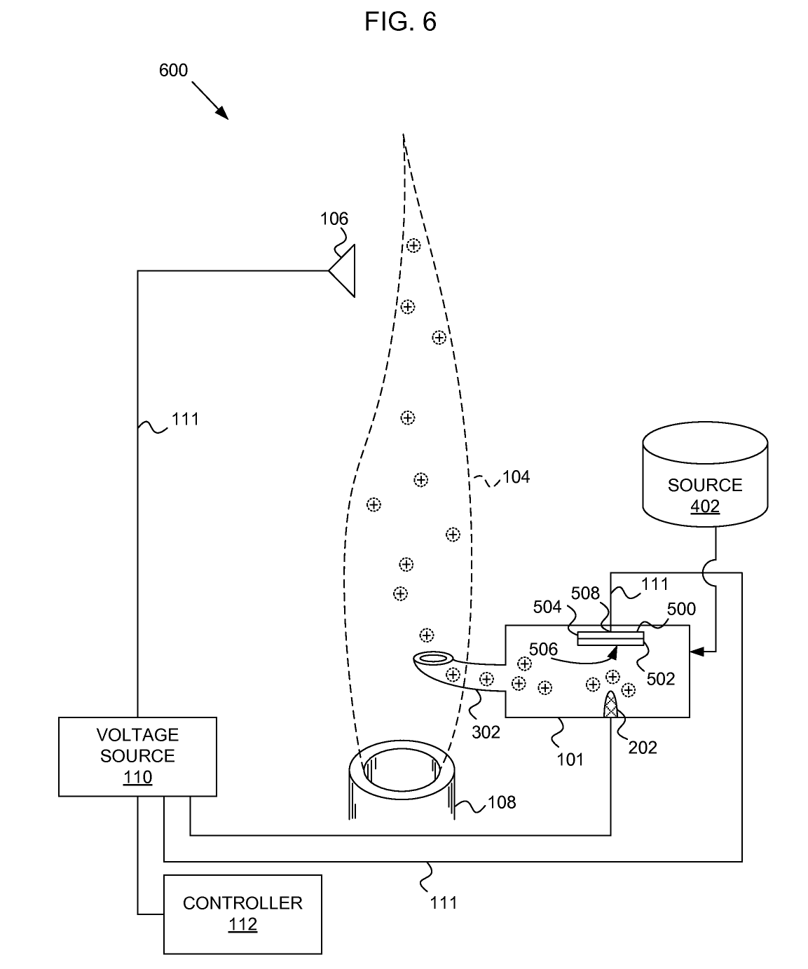

FIG. 6 is a diagram showing a combustion system 600 according to an embodiment. The combustion system 600 includes an ionizer mechanism 602 and a burner 108 configured to support a combustion reaction 104. Other elements shown are described with reference to other embodiments, and so will not be described here.

The ionizer mechanism 101 includes a corona electrode 202 and a counter electrode 500, substantially as described with reference to FIG. 5.

In operation, the porous first layer 502 of the counter electrode 500 serves to significantly increase the effective electrical breakdown voltage, permitting application of voltage levels Vₜ that would otherwise provoke electrical breakdown and a subsequent short-circuiting electric arc.

While the mechanism by which this increase in the effective breakdown voltage is produced is not fully understood, the inventors have theorized that the open-cell porous structure of the first layer 502 acts as a very large plurality of parallel conductors, to transmit current from the second conductor 504 to the front face 506 of the electrode 500. As is well understood, the resistance of a parallel circuit is equal to the reciprocal of the sum of the reciprocals of each of the individual resistances. This means that, collectively, a large plurality of highly resistive conductors connected in parallel can appear as a single, very low-resistance conductor. Thus, even a very high-voltage signal can be transmitted with little or no attenuation.

In a typical ionizer circuit, when the nominal electrical breakdown voltage of an ionizer is exceeded, an electric arc is formed that follows a single low-resistance path of ions through the fluid between the electrodes. Such a path will contact the counter electrode at a single point. However, in the case of the electrode 500, an electric arc is subject to the point contact resistance of the first layer 502, which is much greater than the resistance of a typical counter electrode. No path from a point contact on the front face 506 that the arc might follow through the first layer 502 has the low broad contact resistance of the electrode, but instead has the very high point contact resistance of. This high resistance acts as a current limiter, preventing formation of an arc.

A characteristic of the electrode 500, therefore, is that its point contact resistance is relatively high, while its broad contact resistance is very small, such that operation of the electrode in the formation of ions is not significantly impaired. Preferably, the resistivity and porosity of the material of the first layer 502 of the electrode 500 is selected such that a point contact resistance of the electrode is sufficient to prevent electrical breakdown and formation of an arc discharge at the maximum design voltage of the ionizer mechanism 101. According to an embodiment, the point contact resistance of the electrode is at least two orders of magnitude greater than the broad contact resistance. According to another embodiment, the point contact resistance is at least three orders of magnitude greater than the broad contact resistance.

According to an embodiment, the point contact resistance of the electrode 500 is sufficient to limit a current from a point contact to the contact terminal 508 to less than about 10 mA, given a voltage across the electrode equal to the maximum design voltage of the ionizer mechanism 101. For example, assuming that the ionizer mechanism 101 is designed to operate at a voltage difference between the corona electrode 202 and the counter electrode 500 of up to 20 kV, the point contact resistance is at least 20 MΩ (i.e.: 20³/1⁻³=20⁶).

According to an embodiment, a voltage drop across the electrode 500 during normal operation of the ionizer mechanism 500 at its maximum design voltage is less than about 10% of the applied voltage. Because the counter electrode 500 enables a much higher corona current Iₜ, in some embodiments, the ionizer mechanism 101 is capable of generating sufficient ions with a single ionizer stage, as shown in the embodiment of FIG. 6. According other embodiments, the ionizer mechanism 101 includes a plurality of ionizer stages, similar to the mechanisms described with reference to other embodiments, each of the plurality of stages having a counter electrode with a structure similar to the electrode 500 described with reference to FIG. 5.

In addition to the protection against arc discharge events, use of a porous layer on the counter electrode of an ionizer provides other advantages over conventional electrodes. Because ionizers typically operate at very high voltages, the electrodes tend to attract dust particles, particularly when used in combustion systems, which produce large amounts of dust and small particulates. As the counter electrode accretes a layer of dust, the particles form micro-needles that behave like corona electrodes, generating parasitic “counter” ions of a polarity opposite those formed by the corona electrode of the ionizer. With ions being formed by both electrodes, they will tend to attract each other and cancel charges, reducing the net output of the device. However, the porous first layer has an effective surface area that is many times greater than that of a conventional electrode of equivalent dimensions. Accretion of a dust layer thick enough to produce substantial quantities of counter ions therefore takes much longer, which reduces down time required for service.

Additionally, in systems that introduce atomized or vaporized liquid as a donor material for charge carriers, the liquid can condense into droplets on the surface of a conventional counter electrode. As a layer of liquid forms, this can reduce the effective distance of the dielectric gap, reducing the electrical breakdown voltage and increasing the likelihood of an arc discharge event. However, the porous first layer of the electrode 500 can absorb a significant quantity of liquid while maintaining a nominal electrical breakdown voltage value.

Finally, because of the high voltages employed, many ionizers present a significant danger of electric shock if a person inadvertently touches the electrodes. However, in the case of the porous first layer 502, contact across a small area of the electrode will be current limited, as described above, so, while a perceptible shock may be delivered, the danger of serious injury is reduced. Furthermore, the individual is more likely to reflexively withdraw before making contact across sufficient surface area to receive a dangerous shock.

The inventors have discovered that the use of atomized water droplets in a gaseous transport fluid can enable production of very high quantities of ions. This is surprising because water outperforms other ion donor materials that might be expected to perform similarly. Also, although water is an electronegative material, and might therefore be expected to be a poor donor of positive ions, when introduced as atomized droplets, water is effective also in producing positive ions.

A particular issue that system designers face is that ions have a charge with a particular polarity, and are repelled by charges of the same polarity and attracted toward charges of the opposite polarity. This means that when an ion is produced in the plasma region near a corona electrode, it is repelled by that electrode while being attracted by the counter electrode, and thus moves toward the counter electrode. If the ion contacts the counter electrode, it will release its charge and return to a neutral state. This provides no benefit in a device configured to emit ions. In many cases, ions simply overshoot the counter electrode and quickly move beyond a distance at which the counter electrode can draw them back. Often, ion generators rely on ionic wind or some other mechanism to move the fluid and carry a majority of ions past the counter electrodes before they can make contact. However, in the case of a multiple-stage ionizer mechanism, the ions may be required to bypass one or more additional counter electrodes downstream before they can escape the device, and many of the ions may be carried very near the additional counter electrodes by the transport fluid as they pass. In such arrangements, contact with a downstream counter electrode is a particular possibility. If large numbers of ions are neutralized by downstream electrodes, this can have a significantly impact on the overall charge available to impart to the combustion reaction.

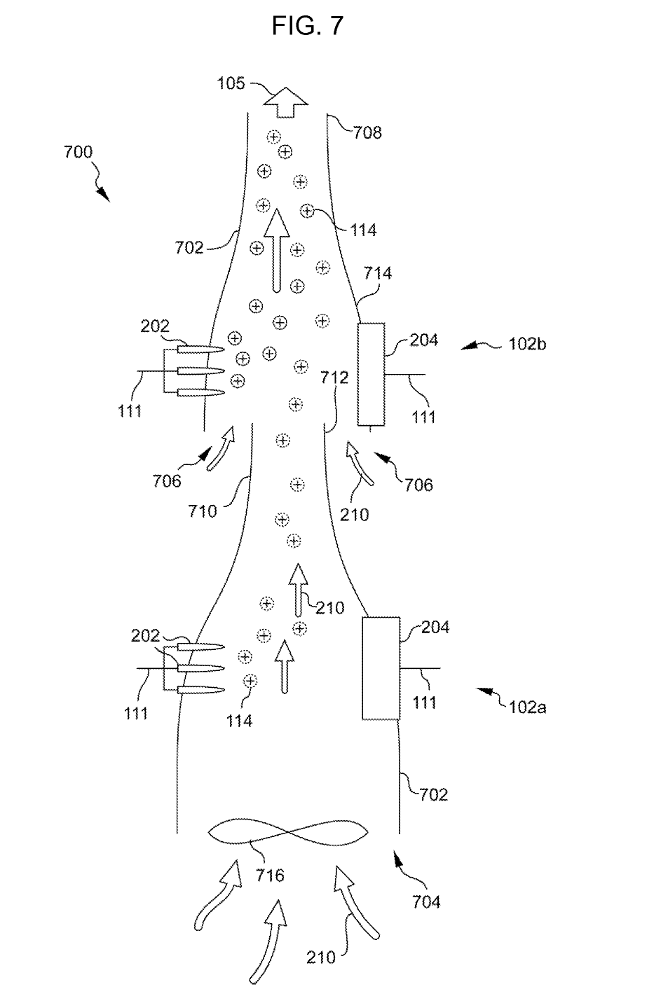

FIG. 7 is a diagram showing a multi-stage ionizer mechanism 700, according to an embodiment. The ionizer mechanism 700 is configured to produce ions 114 for use with combustion systems, such as, for example, those described with reference to FIGS. 1, 3B, 4, and 6. The ionizer mechanism 700 includes a first ionizer stage 102a and a second ionizer stage 102b, each including a respective plurality of corona electrodes 202 and a counter electrode 204. The corona electrodes 202 and counter electrodes 204 are coupled to a voltage supply and controller via connectors 111, as described previously. The plurality of corona electrodes 202 shown in FIG. 7 is merely exemplary. It is well known that under some circumstances, multiple corona electrodes 202 or corona electrodes 202 with multiple small-radius prominences can be used to produce large quantities of ions.

The ionizer mechanism 700 also includes a housing 702 through which the transport fluid 210 flows, carrying ions 114 along the ion flow path 105. The housing 702 includes a primary fluid inlet 704, secondary fluid inlets 706, and a fluid outlet 708. Additionally, the housing 702 includes a narrowed region 710 between the first ionizer stage 102a and the second ionizer stage 102b, followed by a venturi nozzle 712 and a widened region 714, in which the second ionizer stage is positioned. A fluid pump 716 is provided, configured to impel the transport fluid 210 through the housing 702 at a selected velocity. The fluid pump can be any mechanism capable of imparting sufficient movement to the fluid, such as a fan, compressor, propeller, impellor, etc. Alternatively, fluid can be impelled by a supply pressure of the fluid, by ionic wind, or by a combination of mechanisms.

In operation, transport fluid 210 is introduced into the housing 702 of the ionizer mechanism 700 at the primary fluid inlet 704 via the fluid pump 716. As the transport fluid 210 passes between the corona electrodes 202 and counter electrode 204 of the first ionizer stage 102a, charge carriers within the transport fluid 210 are ionized, particularly in a region immediately surrounding the corona electrodes 202. The charge carriers can be molecules of the transport fluid or of dissociated components thereof, or can be molecules of a separate donor material incorporated with the transport fluid to supply charge carriers. The ions begin to move away from the corona electrodes 202 and toward the counter electrode 204, but are carried past the counter electrode 204 by the flow of the transport fluid 210 before they can make contact. As the ions approach the second ionizer stage 202b, the narrowed region 710 of the housing 702 causes the transport fluid 210 to accelerate and increase in pressure, until it passes through the venturi nozzle 712 at the increased velocity and pressure.

The secondary fluid inlets 706 are positioned, relative to the venturi nozzle 712, such that additional transport fluid 210 is drawn into the housing 702 through the secondary fluid inlets by the venturi effect produced by the passage of fluid from the nozzle 712. The additional transport fluid 210 is entrained by the fluid passing from the venturi nozzle 712 and merges with the flow 105. The corona electrodes 202 and the counter electrode 204 are positioned in the widened region of the housing directly downstream from the venturi nozzle 712 and secondary fluid inlets 706. Ions 114 generated in the first ionizer stage 102a are entrained in the flow of transport fluid 210 that passes from the venturi nozzle 712, and are thus traveling near the center of the passage at a considerable velocity as they pass into the widened region 714. Furthermore, the transport fluid 210 being drawn in via the secondary fluid inlets 706 passes across the corona and counter electrodes 202, 204 of the second ionizer stage 102b as it merges with the stream of transport fluid 210. Thus, ions 114 from the first ionizer stage 102a are substantially prevented from reaching the counter electrode 204 of the second ionizer stage 202b before they are carried past the second stage. Finally, the flow of transport fluid 210 passes out of the ionizer mechanism 700 via the fluid outlet 708, to be introduced to a combustion reaction.

In some systems, it is desirable to limit or reduce the volume of the transport fluid 210 that is introduced to a combustion reaction, while still providing a large quantity of ions. Thus, it is desirable to produce a flow of transport fluid with not only an increased quantity of ions, but with an increased ion density, so that less transport fluid 210 is required.

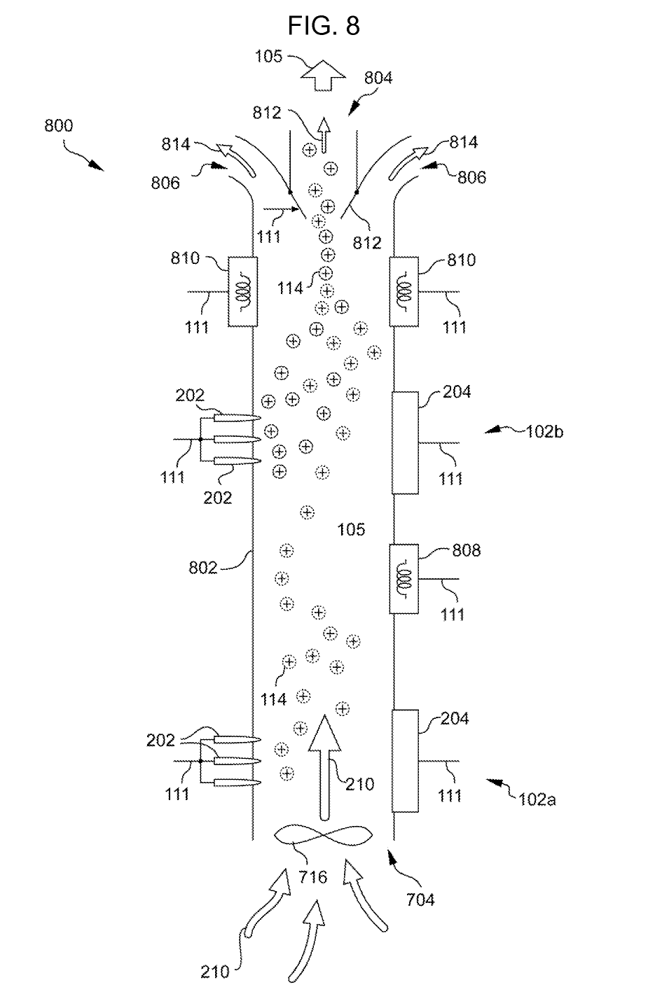

Turning now to FIG. 8, a diagram is provided, showing a multi-stage ionizer mechanism 800, according to an embodiment. The ionizer mechanism 800 is configured to produce ions 114 for use with combustion systems, such as, for example, those described with reference to FIGS. 1, 3B, 4, and 6. The ionizer mechanism 800 includes a first ionizer stage 102a and a second ionizer stage 102b, each including a respective plurality of corona electrodes 202 and a counter electrode 204, coupled to a voltage supply 110 and controller 112 via connectors 111. An ion deflection element 808 is positioned between the first and second ionizer stages 102a, 102b, and an ion focusing element 810 are positioned downstream from the second ionizer stage 102b. The ion deflection element 808 and ion focusing element 810 are operatively coupled to the voltage source 110 and controller 112 via connectors 111. Each is configured to radiate a respective selected polarized electric or electromagnetic field toward the ion flow path 105 when energized via the respective connector 111.

In the embodiment shown, the ion deflection element 808 includes an electromagnetic coil positioned upstream from the second ionizer stage 102b, on a same side of the ion flow path 105 as the counter electrode 204 of the second ionizer stage 102b, and configured to radiate electromagnetic energy of a selected polarity across the flow path toward the side opposite the deflection element 808. The ion focusing element 810 includes a plurality of electromagnetic coils distributed around the ion flow path 105 and configured to radiate electromagnetic energy of a same polarity from each coil toward a center of the flow path 105. According to other embodiments, the ion deflection element 808 and ion focusing element 810 can be any appropriate structure capable of functioning as described, such as, for example, electrodes having structures similar to that of the counter electrode 204, permanent magnets, etc.

The ionizer mechanism 800 also includes a housing 802 through which the transport fluid 210 flows, carrying ions 114 along the ion flow path 105. The housing 802 includes a fluid inlet 704, a primary fluid outlet 804, and one or more secondary fluid outlets 806. A regulator valve 812 is positioned at the primary fluid outlet 804, operatively coupled to the controller and configured to regulate an opening size of the primary fluid outlet. A fluid pump 716 is configured to impel the transport fluid 210 through the housing 802 at a selected velocity.

In operation, transport fluid 210 is introduced into the housing 802 of the ionizer mechanism 800 at the fluid inlet 704 via the fluid pump 716. Charge carriers within the transport fluid 210 are ionized as the transport fluid passes between the corona electrodes 202 and counter electrode 204 of the first ionizer stage 102a. The resulting ions move downstream and toward the counter electrode 204, but are carried past the counter electrode by the flow of the transport fluid. The ion deflection element 808 is energized to radiate electromagnetic energy of a same polarity as that of the ions. As the ions approach the second ionizer stage 202b, they are repelled by the electromagnetic field produced by the ion deflection element 808 and are thereby driven toward the opposite side of the housing 802. Thus, although the ions 114 are attracted toward the counter electrode 204 of the second ionizer stage 102b, the flow of transport fluid 210 caries them past before they can cross from the opposite side of the housing 802. The majority of ions 114 are thus prevented from contacting the counter electrode 204 as they pass. Additional ions are formed in the second ionizer stage 102b and join the previously formed ions within the flow of transport fluid 210.

Because the ions 114 are all charged at a same potential, they are mutually repulsive, and will tend, over time, to distribute themselves evenly within the flow of fluid. However, the ion focusing element 810, is energized to radiate electromagnetic energy of the same polarity from each side of the ion flow path 105, thereby driving the ions together into a narrow stream at the center of the fluid flow. The primary and secondary outlets 804, 806 are positioned at the downstream end of the housing 802 so that only a portion at the center of the fluid flow passes through the primary outlet, while the remaining transport fluid 210 exits the housing via one of the secondary outlets 806. Because the ions 114 have been focused into a narrow stream at the center of the flow by the focusing coils 810, substantially all of the ions exit the housing via the primary outlet 804, which is operatively coupled to a conduit or other mechanism configured to introduce the reduced flow of transport fluid 210 to a combustion reaction. Transport fluid 210 exiting the housing 802 via a secondary outlet 806 can be disposed of in any of a number of different ways. For example, depending on the character of the transport fluid 210, excess transport fluid can be returned to the fluid source to be recycled. i.e., in cases, for example, where fuel is employed as the transport fluid, the secondary outlets 806 can be operatively coupled to the fuel source to return the excess fluid. On the other hand, where air is used as the transport fluid 210, the excess fluid can simply be released to the atmosphere. Where flue gas is used as the transport fluid 210, as well as for exhaust gas recirculation, the excess can be released into the exhaust flow downstream from the combustion reaction 104.

In embodiments that include the regulator valve 812, the volume of transport fluid that is permitted to exit the housing via the primary outlet 804 is controlled dynamically by the controller. In this way, the volume of transport fluid 210 that is introduced to the combustion reaction can be regulated without affecting the quantity of ions 114 that are introduced. As noted in previous embodiments, the voltage applied to the ionizer stages 102 can also be regulated, permitting dynamic control of ion production, independent of the volume of transport fluid.

According to an alternative embodiment, regulator or bypass valves are positioned to regulate the flow of transport fluid through one or more of the secondary outlets.

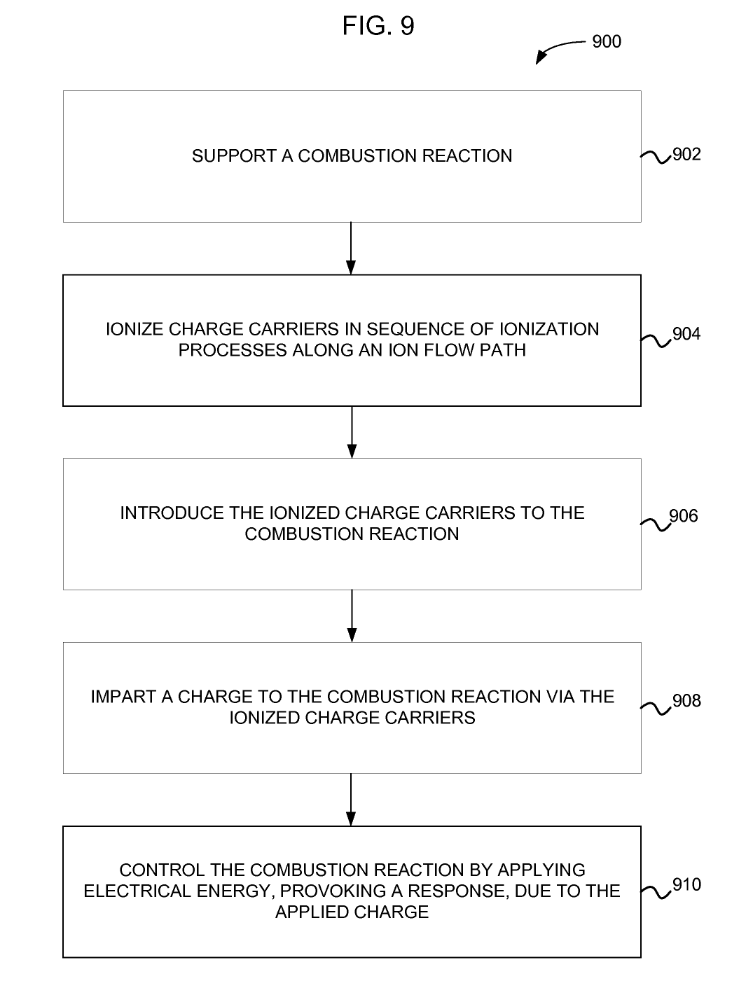

FIG. 9 is a flow chart of a method 900 for using an ionizer mechanism that includes a plurality of ionizer stages to control a combustion reaction, according to an embodiment. A combustion reaction is supported in step 902.

In step 904, a flow of charge carriers is ionized along an ion flow path. According to an embodiment, the charge carriers are ionized using an ionizer mechanism, which can include one or a plurality of ionizer stages located sequentially along the ion flow path. Step 904 includes using a plurality of corona electrodes and counter electrodes to sequentially ionize a flow of charge carriers.

According to some embodiments, the corona electrode and the counter electrode pairs are characterized by an electrode separation at each of the plurality of ionizer stages. Pairs of adjacent ones of the plurality of ionizer stages include a downstream ionizer stage and an upstream ionizer stage. The downstream ionizer stage is separated from the upstream ionizer stage by an inter-ionizer stage separation that is greater than the electrode separation of the upstream ionizer stage.

According to some embodiments, the inter-ionizer stage separation is between about 1.5 times the electrode separation of the upstream ionizer stage and about 2.5 times the electrode separation of the upstream ionizer stage. According to an embodiment, the inter-ionizer stage separation is about 2 times the electrode separation of the upstream ionizer stage.

According to an embodiment, a polarity of each ionizer stage of the plurality of ionization stages may be independently controlled. Additionally or alternatively, the plurality of ionizer stages is dynamically controlled. Each ionizer stage may be controlled to have the same polarity. Alternatively, each sequential pair of ionizer stages in the plurality of ionizer stages may be controlled to have opposing polarity.

According to an embodiment, ionizing the charge carriers includes, for example, providing the charge carriers to a plurality of ionizer stages in sequence, in the form of a fuel, an oxidant, a particulate additive, a liquid additive, a gas additive, an aerosol additive, a solute additive in a liquid solution, or a combination thereof. Provision of the charge carriers to the ionizer stages may include, for example, nebulizing, atomizing, injecting, steam generating, ultrasonic humidifying, vaporizing, evaporating, pumping, or a combination thereof.

Stages of the ionizer mechanism may each include a corona electrode that includes silver. Proceeding to step 906, the charge carriers are introduced to the combustion reaction. The charge carriers may include components of air (e.g., nitrogen, oxygen, carbon dioxide, etc.) or flue gas, or may include fuel, for example. In other embodiments, the charge carriers include particulates, water, and/or other components added to the combustion reaction exclusively or primarily for the purpose of carrying the charge to the combustion reaction.

The ionized charge carriers are directed to the combustion reaction along the ion flow path in step 906. Directing the charge carriers along the ion flow path may include conveying the ionized charge carriers from the plurality of ionizer stages of the ionizer mechanism to the combustion reaction, using a conduit. The conduit includes a material resistant to the charge carriers and the ionized charge carriers.

The conduit can be electrically insulated. Additionally, the conduit can be held at a polarity of the ionized charge carriers. The conduit may be protected from heat of the combustion reaction by thermal reflection, thermal insulation, and/or active cooling, etc.

According to an embodiment, the ionized charge carriers are introduced in proximity to a burner or fuel source at a separation of less than a diameter of an outlet of the burner or fuel source. Alternatively, the ionized charge carriers may be provided upstream of the outlet of the burner or fuel source, upstream being with respect to a flow of the combustion reaction.

Proceeding to step 908, a charge is imparted to the combustion reaction by the ionized charge carriers.

In step 910, the combustion reaction is controlled by application of electrical energy. The charge imparted to the combustion reaction by the ions causes the combustion reaction to respond in a predictable manner. For example step 910 may include applying electrical energy to a conductive flame holder resulting in at least intermittently holding a portion of the combustion reaction at the flame holder.

The electrical energy applied to the conductive flame holder may include drawing the portion of the combustion reaction in a first direction towards the flame holder in step 910. Additionally, in step 906, introducing the ionized charge carriers to the combustion reaction may include directing the ionized charge carriers towards the flame holder. The conductive flame holder may be a separate electrode, a burner, or fuel source, etc.

In step 910 the electrical energy can be applied as a charge, a voltage, an electrical field or a combination thereof. Electrical energy application may be one or more of a time-varying majority charge, a time-varying voltage, a time varying electric field, or a combination thereof.

Optionally, the method 900 may include detecting a short circuit at a corona electrode in a stage of the ionizer mechanism, in response to which a reduced voltage is applied to the shorted corona electrode, or the voltage is shut off completely.

Various embodiments are depicted and described in which an ionizer mechanism includes a plurality of ionizer stages, incorporated into a single unit or housing. According to other embodiments, the ionizer mechanism includes a plurality of ionizer stages in separate units, an upstream unit having an outlet operatively coupled to an inlet of a downstream unit, so that transport fluid and ions are transmitted from the ionizer of the upstream unit to the ionizer of the downstream unit. The downstream unit includes an outlet that is configured to be operatively coupled to the combustion volume of a combustion system, for introduction of the ions to the combustion reaction.

As used in the specification, the symbols “Ω” is used to refer to values of electrical resistance, in ohms, the symbol “A” is used to refer to values of electrical current, in amps, and the symbol “V” is used to refer to values of electrical potential, in volts. Modifiers m, k, and M are used according to accepted practice, to refer to multiples of 10⁻³·10³, and 10⁶, respectively.

Structures configured to electrically connect components or assemblies shown in the drawings are depicted generically as connectors, inasmuch as electrical connectors and corresponding structures are very well known in the art, and equivalent connections can be made using any of a very wide range of different types of structures. The connectors can be configured to carry high-voltage signals, data, control logic, etc., and can include a single conductor or multiple separately-insulated conductors. Additionally, where a voltage potential, control signal, feedback signal, etc., is transmitted via intervening circuits or structures, such as, for example, for the purpose of amplification, detection, modification, filtration, rectification, etc., such intervening structures are considered to be incorporated as part of the respective connector. Where other methods of signal or data transmission are used, such as via, e.g., fiber optics or wireless systems, such alternative structures are considered to be equivalent to the connectors depicted here.

According to embodiments, the combustion reaction 104 can be supported by either a diffusion, partial premix, or premixed burner.

According to a premixed burner embodiment, the ion (or charged particle) flow 105 can be introduced to the combustion reaction through a premixing chamber. For example, a charged particle source such as a corona electrode 202 and counter electrode 204 pair can be disposed in the premixing chamber, and the premixing chamber and any flame arrestor can be held or allowed to float to a voltage that allows the charged particle flow 105 to pass through the flame arrestor and into the combustion reaction. In another example, a charged particle delivery conduit 302 can deliver the charged particle flow 105 from a charged particle source into the premixing chamber.

In another premixed burner embodiment, the charged particle flow 105 can be introduced above a flame arrestor and below a flame holder into a premixed fuel/air flow. The charged particle flow can be generated by a charged particle source such as a corona electrode 202 and counter electrode 204 pair can be disposed in the premixed fuel/air flow between the flame arrestor and below the flame holder, and the flame arrestor or other conductive surface past which the charged particles may flow (e.g., the flame holder) can be held or allowed to float to a voltage that allows the charged particle flow 105 to pass through the flame holder and into the combustion reaction 104. In another example, a charged particle delivery conduit 302 can deliver the charged particle flow 105 from a charged particle source into the premixed fuel/air flow between the flame arrestor and below the flame holder. Of course, if it is desired to cause the fuel/air flow to support a combustion reaction 104 that is held by the flame holder, then the flame holder can optionally be configured as the first electrode 106 (and be held at a voltage different from a voltage that would allow the charged particle flow 105 to pass by the flame holder. In the case of an aerodynamic flame holder, the flame holder can be formed from an electrically insulating material or can be held or allowed to float to an equilibrium voltage. In this case, the resultant charge concentration in the combustion reaction 104 can be used for purposes other than holding the combustion reaction 104.

In another premixed burner embodiment, the ion flow 105 can be introduced above a flame holder into a premixed fuel/air flow and/or into a combustion reaction above a flame holder. The ion flow can be generated by a charged particle source, such as a corona electrode 202 and counter electrode 204 pair, can be disposed outside the combustion volume. A charged particle delivery conduit 302 can deliver the charged particle flow 105 from the charged particle source into the fuel/air flow or into the combustion reaction 104.

With reference to an AC signal, the term peak-to-peak refers to a value equal to the difference between the maximum positive and the maximum negative amplitudes of the waveform of an AC signal. The term peak refers to a value that is half the peak-to-peak value of a given AC signal. The term dynamic control is used to refer to a value or characteristic that is not fixed, but that may be modified or adjusted. For example, a feedback control loop might include the dynamic control of a burner fuel valve to maintain a temperature value of a boiler in response to boiler load changes.

The abstract of the present disclosure is provided as a brief outline of some of the principles of the invention according to one embodiment, and is not intended as a complete or definitive description of any embodiment thereof, nor should it be relied upon to define terms used in the specification or claims. The abstract does not limit the scope of the claims.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A combustion system, comprising:
a burner configured to support a combustion reaction;
a first electrode positioned and configured to apply electrical energy to a combustion reaction supported by the burner;
an ionizer mechanism, including:
a first ionizer stage configured to ionize charge carriers travelling along an ion flow path;
a second ionizer stage positioned downstream from the first ionizer stage along the ionizer flow path, configured to ionize additional charge carriers travelling along the ion flow path;
an outlet positioned downstream from the second ionizer stage along the ionizer flow path; and
a conduit operatively coupled to the outlet of the ionizer mechanism and configured to introduce charge carriers travelling along the ion flow path to the combustion reaction supported by the burner.

2. The combustion system of claim 1, further comprising a voltage source operatively coupled to the first electrode and to each of the first and second ionizer stages.

3. The combustion system of claim 2, further comprising a controller operatively coupled to the voltage source and configured to control respective voltage signals produced by the voltage source and applied to the first electrode and the first and second ionizer stages.

4. The combustion system of claim 3, wherein the controller is configured to control a signal applied to one of the first and second ionizer stages to include a DC signal component and an AC signal component.

5. The combustion system of claim 3, wherein the controller is configured to control the signal applied to one of the first and second ionizer stages to include an AC signal component having a peak amplitude and a DC signal component having a voltage value that is substantially equal to the peak amplitude of the AC component.

6. The combustion system of claim 3, wherein the controller is configured to control the signal applied to one of the first and second ionizer stages to include a DC signal component having a peak amplitude and an AC signal component having a voltage value that is substantially equal to the peak amplitude of the AC component.

7. The combustion system of claim 3, wherein the controller is configured to control the signal applied to one of the first and second ionizer stages to include an AC signal component having a peak amplitude and a DC signal component having a voltage value that is at least one order of magnitude greater than the AC component.

8. The combustion system of claim 3, wherein the controller is configured to control the signal applied to one of the first and second ionizer stages to include an AC signal component having a peak amplitude and a DC signal component having a voltage value that is at least two orders of magnitude greater than the AC component.

9. The combustion system of claim 3, wherein the controller is configured to control a signal applied to each of the ionizer stages of the ionizer mechanism to include a DC signal component and an AC signal component.

10. The combustion system of claim 3, wherein the controller is configured to dynamically and independently control a signal applied to each of the ionizer stages.

11. The combustion system of claim 3, wherein the voltage source is operatively coupled to the conduit, and the controller is configured to control the voltage source to apply a voltage to the conduit having a polarity corresponding to a polarity of the charge carriers travelling along the ion flow path.

12. The combustion system of claim 1, wherein each of the first and second ionizer stages includes a corona electrode and a counter electrode, and is configured to apply a voltage across the corona and counter electrodes of the respective ionizer stages.

13. The combustion system of claim 12 wherein a smallest distance between an electrode of the first ionizer stage and an electrode of the second ionizer stage is greater than a distance between the corona and counter electrodes of the first ionizer stage.

14. The combustion system of claim 12 wherein a smallest distance between an electrode of the first ionizer stage and an electrode of the second ionizer stage is at least 1.5 times greater than a distance between the corona and counter electrodes of the first ionizer stage.

15. The combustion system of claim 12 wherein a smallest distance between an electrode of the first ionizer stage and an electrode of the second ionizer stage is at least 2.5 times greater than a distance between the corona and counter electrodes of the first ionizer stage.

16. The combustion system of claim 12 wherein the counter electrode of at least one of the ionizer stages of the ionizer mechanism includes a porous layer of a material having a high intrinsic resistance.

17. The combustion system of claim 12 wherein the material of the porous layer includes a melamine compound.

18. The combustion system of claim 12 wherein the counter electrode of at least one of the ionizer stages of the ionizer mechanism includes a porous, open-cell foam layer.

19. The combustion system of claim 17, comprising a charge carrier source configured to introduce atomized water to the ionizer mechanism.

20. The combustion system of claim 12 wherein the counter electrode of at least one of the ionizer stages of the ionizer mechanism includes a porous layer of a semiconductor-type material.

21. The combustion system of claim 1 wherein the ionizer mechanism is configured to separate a portion of a transport fluid carrying the charge carriers from the ion flow path prior to conveying a remainder of the transport fluid and substantially all of the ionized charge carriers to the outlet of the ionizer mechanism.

22. The combustion system of claim 21, further comprising a controller operatively coupled to the ionizer mechanism and configured to dynamically control a volume of the remainder of the transport fluid relative to a volume of the portion of the transport fluid.

23. The combustion system of claim 1, wherein the ionizer mechanism further includes a third ionizer stage positioned downstream from the second ionizer stage along the ionizer flow path, configured to ionize additional charge carriers travelling along the ion flow path.

24. The combustion system of claim 1, wherein the conduit includes a structure configured to protect portions of the conduit from heat produced by the combustion reaction.

25. The combustion system of claim 1, wherein the conduit includes an outlet positioned within a distance of the burner defined by a diameter of the burner.

26. The combustion system of claim 1, wherein the conduit includes an outlet positioned upstream an outlet of the burner along a flow of the combustion reaction.

27. The combustion system of claim 1, further comprising a second electrode positioned and configured to apply electrical energy to the combustion reaction.

28. The combustion system of claim 27, wherein the second electrode is positioned upstream from the first electrode along a flow of the combustion reaction.

29. The combustion system of claim 27, wherein the conduit is configured to introduce the charge carriers upstream from the second electrode along a flow of the combustion reaction.

30. The combustion system of claim 1, further comprising a fluid source having an outlet coupled to an inlet of the ionizer mechanism and configured to introduce a transport fluid to the ion flow path.

31. An ionizer mechanism for generating ions for controlling a combustion reaction, comprising:
a first ionizer stage configured to ionize charge carriers travelling along an ion flow path;
a second ionizer stage positioned downstream from the first ionizer stage along the ionizer flow path, configured to ionize additional charge carriers travelling along the ion flow path; and
a conduit configured to introduce the charge carriers travelling along the ion flow path to the combustion reaction.

32. The ionizer mechanism of claim 31, wherein each of the first and second ionizer stages includes a corona electrode and a counter electrode, and is configured to apply a voltage across the corona and counter electrodes of the respective ionizer stages.

33. The ionizer mechanism of claim 32, wherein a smallest distance between an electrode of the first ionizer stage and an electrode of the second ionizer stage is greater than a distance between the corona and counter electrodes of the first ionizer stage.

34. The ionizer mechanism of claim 32, wherein a smallest distance between an electrode of the first ionizer stage and an electrode of the second ionizer stage is at least 1.5 times greater than a distance between the corona and counter electrodes of the first ionizer stage.

35. The ionizer mechanism of claim 32, wherein a smallest distance between an electrode of the first ionizer stage and an electrode of the second ionizer stage is at least 2.5 times greater than a distance between the corona and counter electrodes of the first ionizer stage.

36. The ionizer mechanism of claim 31, wherein the ionizer mechanism is configured to separate a portion of a transport fluid carrying the charge carriers from the ion flow path prior to conveying a remainder of the transport fluid and substantially all of the ionized charge carriers to the conduit.

37. The ionizer mechanism of claim 31, further comprising a controller configured to dynamically control a volume of the remainder of the transport fluid relative to a volume of the portion of the transport fluid.

38. The ionizer mechanism of claim 31, further comprising a third ionizer stage positioned downstream from the second ionizer stage along the ionizer flow path, configured to ionize additional charge carriers travelling along the ion flow path.

39. The ionizer mechanism of claim 31, wherein the conduit includes a structure configured to protect portions of the conduit from heat produced by the combustion reaction.

40. The ionizer mechanism of claim 31, further comprising a fluid source configured to introduce a transport fluid to the ion flow path.

41. A method of controlling a, comprising:
transporting charge carriers along an ion flow path;
ionizing a first plurality of the charge carriers at a first ionizer stage positioned along the ion flow path;
ionizing a second plurality of the charge carriers at a second ionizer stage positioned downstream from the first ionizer stage along the ion flow path;
and introducing the first and second pluralities of charge carriers to the combustion reaction.

42. The method of claim 41, wherein the transporting charge carriers along an ion flow path comprises transporting the charge carriers from the first first ionizer stage to the second ionizer stage a distance that is greater than a distance between a coronal electrode and a counter electrode of the first ionizer stage.

43. The method of claim 41, wherein the transporting charge carriers along an ion flow path comprises transporting the charge carriers from the first first ionizer stage to the second ionizer stage a distance that is at least 1.5 times greater than a distance between a coronal electrode and a counter electrode of the first ionizer stage.

44. The method of claim 41, wherein the transporting charge carriers along an ion flow path comprises transporting the charge carriers from the first first ionizer stage to the second ionizer stage a distance that is at least 2.5 times greater than a distance between a coronal electrode and a counter electrode of the first ionizer stage.

45. The method of claim 41, wherein the ionizing a first plurality of the charge carriers comprises applying a voltage signal to the first ionizer stage.

46. The method of claim 45, wherein the applying a voltage signal to the first ionizer stage comprises applying a voltage difference to a corona electrode and a counter electrode of the first ionizer stage.

47. The method of claim 45, wherein the applying a voltage signal to the first ionizer stage comprises applying a voltage signal that includes a DC component and an AC component.

48. The method of claim 45, wherein the applying a voltage signal to the first ionizer stage comprises applying a voltage signal that includes an AC component having a peak value and a DC component having a voltage that is substantially equal to the peak value of the AC component.

49. The method of claim 45, wherein the applying a voltage signal to the first ionizer stage comprises applying a voltage signal that includes an AC component having a peak value and a DC component having a voltage that is at least one order of magnitude greater than the peak value of the AC component.

50. The method of claim 45, wherein the applying a voltage signal to the first ionizer stage comprises applying a voltage signal that includes an AC component having a peak value and a DC component having a voltage that is at least one order of magnitude greater than the peak value of the AC component.

51. The method of claim 45, wherein the applying a voltage signal to the first ionizer stage comprises applying a voltage signal that includes an AC component having a peak value and a DC component having a voltage that is at least two orders of magnitude greater than the peak value of the AC component.

52. The method of claim 41, wherein the transporting charge carriers along an ion flow path comprises transporting the charge carriers from the first first ionizer stage toward the second ionizer stage while applying a force urging charged ions to a side of the ion flow path opposite a side on which a counter electrode of the second ionizer stage is positioned.

53. The method of claim 41, wherein the transporting charge carriers along an ion flow path comprises:
transporting the charge carriers in a transport fluid;
transporting the charge carriers from the first first ionizer stage toward the second ionizer stage while accelerating a flow of the transport fluid and introducing additional transport fluid.

54. The method of claim 41, wherein the transporting charge carriers along an ion flow path comprises transporting the charge carriers in a transport fluid, the method further comprising removing a portion of the transport fluid prior to introducing the first and second pluralities of charge carriers to the combustion reaction.
